(19) United States
(12) Patent Application Publication
(10) Pub. No.: US 2023/0328103 A1
(43) Pub. Date: Oct. 12, 2023

(54) SYSTEMS AND METHODS FOR UPDATING MICROSERVICES SECURE SOCKETS LAYER CERTIFICATE

(71) Applicant: Citrix Systems, Inc., Fort Lauderdale, FL (US)

(72) Inventor: Sathishkumar Kaliavaradhan, Pompano Beach, FL (US)

(21) Appl. No.: 17/715,659

(22) Filed: Apr. 7, 2022

(51) Int. Cl. H04L 9/40; H04L 61/4511; H04L 67/133

(52) U.S. Cl. CPC H04L 63/168; H04L 63/0823; H04L 61/4511; H04L 67/133

(57) ABSTRACT

Described embodiments provide systems and methods for updating a SSL certificate. A method can include sending, by a service executable on at least one server, a request to a vault to identify one or more SSL certificates identifiable by a common name, in response to a first request to access an application service. The service may identify a first SSL certificate having a furthest expiration date among the one or more SSL certificates. The service may store the first SSL certificate in a cache, the first SSL to be used to secure a connection to access the application service.

### FIELD OF THE DISCLOSURE

The present application generally relates to computing systems and environments, including but not limited to systems and methods for updating a secure sockets layer (SSL) certificate.

### BACKGROUND

In current applications, resources such as services and microservices are becoming increasingly ubiquitous. In some applications, a resource is provided by a service provider. Furthermore, current systems can deliver or provision various types of services, applications, desktops, containers and/or other resources using various approaches.

### SUMMARY

This Summary is provided to introduce a selection of concepts in a simplified form that are further described below in the Detailed Description. This Summary is not intended to identify key features or essential features, nor is it intended to limit the scope of the claims included herewith.

The present disclosure is directed towards systems and methods for updating secure sockets layer (SSL) certificate(s) for services such as microservices. For instance, the systems and methods described herein can provide a novel approach for efficiently monitoring SSL certificates in a cluster. In some embodiments, microservices establish a secure communication with clients using SSL certificate encryption. SSL certificates have expiration dates which may be renewed or updated before or after expiration. The update of SSL certificates may involve the redeployment of the microservices with proper certificate permission. Redeployment can be a very slow process and can involve significant effort depending on the number of environments and regions to avoid downtime of services. The present disclosure can improve the performance of microservices by caching a SSL certificate for a configured interval/duration before loading a new/updated certificate from a certificate store and/or key vault.

In one aspect, the present disclosure is directed to a method for updating a SSL certificate. The method can include sending, by a service executable on at least one server, a request to a vault to identify one or more SSL certificates identifiable by a common name, in response to a first request to access an application service. The service may identify a first SSL certificate having a furthest expiration date among the one or more SSL certificates. The service may store the first SSL certificate in a cache. The first SSL can be used to secure a connection to access the application service.

In certain embodiments, the service may determine whether the first SSL certificate is available in the cache, in response to a second request to access the application service or another application service. In some embodiments, the service may determine that the first SSL certificate is available in the cache. The service may provide the first SSL certificate for use to secure the connection to access the application service or a connection to the another application service.

In some embodiments, the service may determine that the first SSL certificate is unavailable in the cache. The service may send another request to the vault to identify another one or more SSL certificates identifiable by the common name. The service may identify a second SSL certificate having a furthest expiration date among the another one or more SSL certificates. The service may store the second SSL certificate in the cache, the second SSL to be used to secure the connection to access the application service or the connection to access the another application service. The service may provide the second SSL certificate to secure the connection to access the application service or the connection to access the another application service. In certain embodiments, the common name may comprise a domain name system (DNS) name or a domain name.

In some embodiments, the service may initiate a timer for the first SSL certificate in the cache. Upon expiration of the timer, the first SSL certificate becomes unavailable in the cache. The first request may include at least one of: an application programming interface (API) request, a microservice request, or a callback event. In certain embodiments, the service stores the first SSL certificate in each of a plurality of caches (e.g., corresponding to a plurality of cluster nodes).

In one aspect, the present disclosure is directed to at least one server comprising at least one processor. The at least one processor may be configured to execute a service to send, via a transmitter, a request to a vault to identify one or more secure sockets layer (SSL) certificates identifiable by a common name, in response to a first request to access an application service. The at least one processor may be configured to identify a first SSL certificate having a furthest expiration date among the one or more SSL certificates. The at least one processor may be configured to store the first SSL certificate in a cache. The first SSL may be stored for later use to secure a connection to access the application service.

In certain embodiments, the at least one processor can be configured to execute the service to determine whether the first SSL certificate is available in the cache, in response to a second request to access the application service or another application service. The at least one processor can be configured to determine that the first SSL certificate is available in the cache. The at least one processor may be configured to provide the first SSL certificate for use to secure the connection to access the application service or a connection to the another application service. In certain embodiments, the at least one processor may be configured to determine that the first SSL certificate is unavailable in the cache. The at least one processor may be configured to send another request to the vault to identify another one or more SSL certificates identifiable by the common name. The at least one processor may be configured to identify a second SSL certificate having a furthest expiration date among the another one or more SSL certificates. The at least one processor may be configured to store the second SSL certificate in the cache, the second SSL to be used to secure the connection to access the application service or the connection to access the another application service. The at least one processor may be configured to execute the service to provide the second SSL certificate to secure the connection to access the application service or the connection to access the another application service. The common name may comprise a domain name system (DNS) name or a domain name. The at least one processor may be configured to execute the service to initiate (e.g., set, configure, or indicate an expiration time for) a timer for the first SSL certificate in the cache. Upon expiration of the timer, the first SSL certificate becomes unavailable in the cache. The at least one processor may be configured to execute the service to store the first SSL certificate in each of a plurality of caches.

In one aspect, the present disclosure is directed to a non-transitory computer readable medium storing program instructions. The program instructions stored in a non-transitory computer readable medium may cause at least one processor to send, via a transmitter, a request to a vault to identify one or more secure sockets layer (SSL) certificates identifiable by a common name, in response to a first request to access an application service. The program instructions may cause the at least one processor to identify a first SSL certificate having a furthest expiration date among the one or more SSL certificates. The program instructions may cause the at least one processor to store the first SSL certificate in a cache. In some embodiments, the first SSL to be used to secure a connection to access the application service.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 1D is a block diagram depicting a computing environment comprising client device in communication with cloud service providers, in accordance with an illustrative embodiment;

FIG. 2 is a block diagram of an appliance for processing communications between a client and a server, in accordance with an illustrative embodiment;

FIG. 3 is a block diagram of systems for updating a SSL certificate, in accordance with illustrative embodiments;

FIG. 4 is a diagram of a process for updating a SSL certificate, in accordance with an illustrative embodiment; and

FIG. 5 is a flow diagram of an example method updating a SSL certificate, in accordance with an illustrative embodiment.

### DETAILED DESCRIPTION

The present disclosure is directed towards systems and methods for updating secure sockets layer (SSL) certificate(s) for services such as microservices. For instance, the systems and methods described herein can provide a novel approach for efficiently monitoring SSL certificates in a cluster. In some embodiments, microservices establish a secure communication with clients using SSL certificate encryption. SSL certificates have expiration dates which may be renewed or updated before or after expiration. The update of SSL certificates may involve the redeployment of the microservices with proper certificate permission. Redeployment can be a very slow process and can involve significant effort depending on the number of environments and regions to avoid downtime of services. The present disclosure can improve the performance of microservices by caching a SSL certificate for a configured interval/duration before loading a new/updated certificate from a certificate store and/or key vault.

For purposes of reading the description of the various embodiments below, the following descriptions of the sections of the specification and their respective contents may be helpful:
Section A describes a network environment and computing environment which may be useful for practicing embodiments described herein;
Section B describes embodiments of systems and methods for delivering a computing environment to a remote user;
Section C describes embodiments of systems and methods for updating a SSL certificate.

### A. Network and Computing Environment

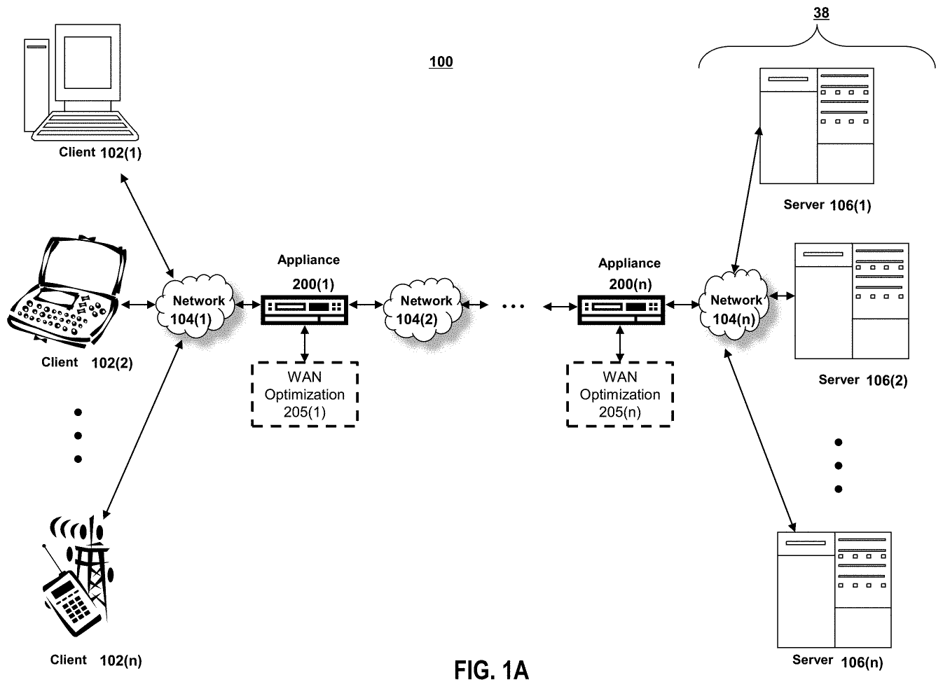

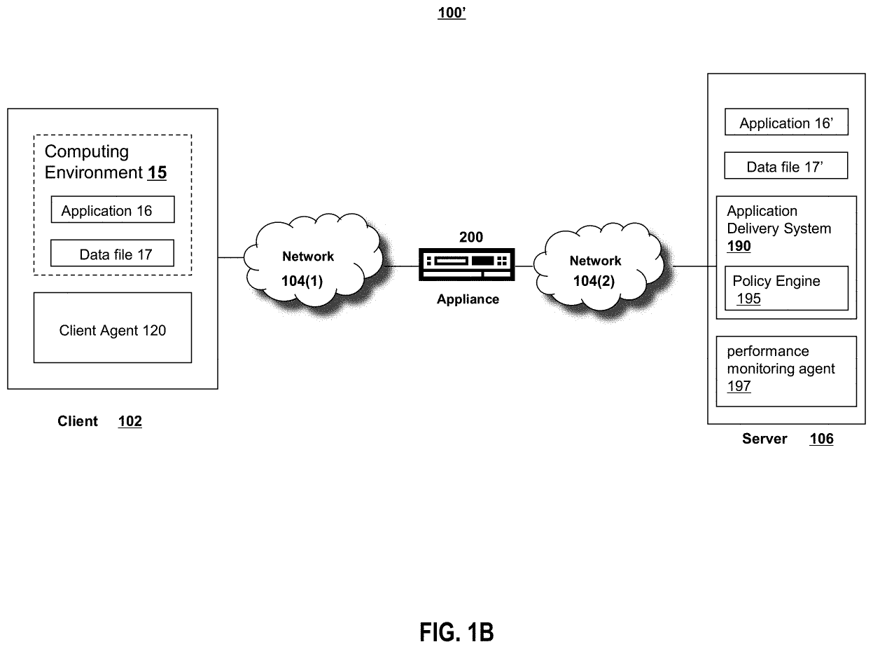

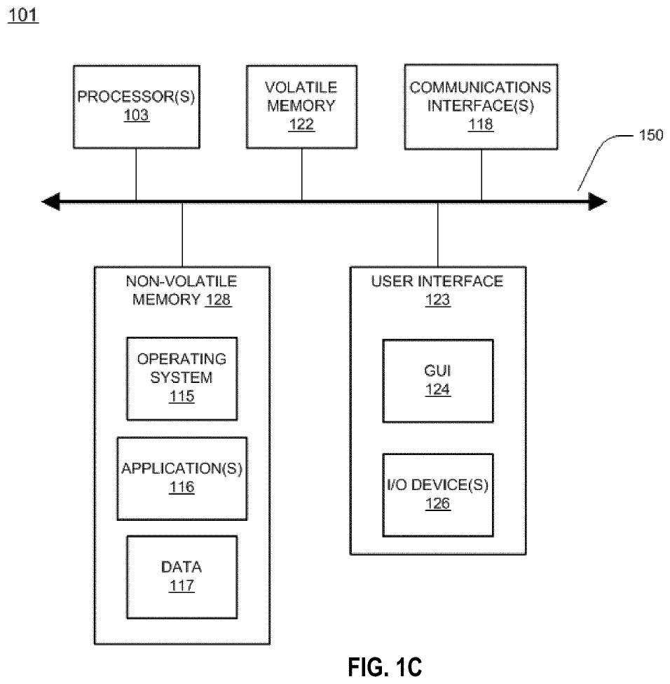

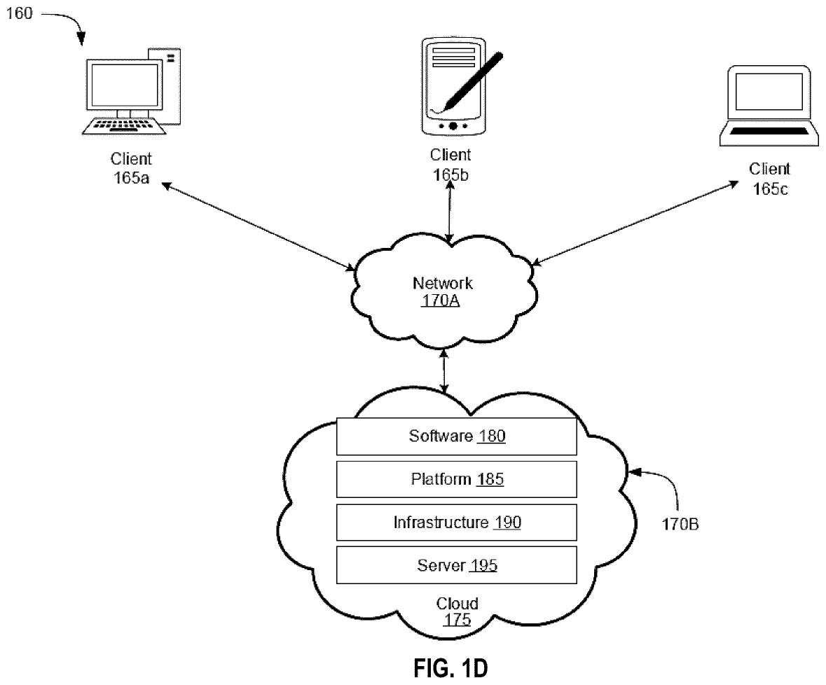

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as Citrix networking (formerly NetScaler®) products sold by Citrix Systems, Inc. of Fort Lauderdale, FL.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, FL.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as Citrix Virtual Apps and Desktops (formerly XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 120 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, FL. The application may be any application related to real-time data communications, such as applications for streaming graphics, streaming video and/or audio or other data, delivery of remote desktops or workspaces or hosted services or applications, for example infrastructure as a service (IaaS), desktop as a service (DaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc. of Fort Lauderdale, FL.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

Additional details of the implementation and operation of network environment 100, clients 102, servers 106, and appliances 200 and 205 may be as described in U.S. Pat. No. 9,538,345, issued Jan. 3, 2017 to Citrix Systems, Inc. of Fort Lauderdale, FL, the teachings of which are hereby incorporated herein by reference.

Referring to FIG. 1D, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers 195, processing, memory, storage, applications, virtual machines, databases, software, hardware, analytics, and intelligence.

In embodiments, the computing environment 160 may provide client 165 with one or more resources provided by a network environment. The computing environment 165 may include one or more clients 165a-165n, in communication with a cloud 175 over one or more networks 170A, 170B. Clients 165 may include, e.g., thick clients, thin clients, and zero clients. The cloud 175 may include back end platforms, e.g., servers 195, storage, server farms or data centers. The clients 165 can be the same as or substantially similar to computer 100 of FIG. 1C.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 175 may include public servers 195 that are maintained by third parties to the clients 165 or the owners of the clients 165. The servers 195 may be located off-site in remote geographical locations as disclosed above or otherwise. Public clouds 175 may be connected to the servers 195 over a public network 170. Private clouds 175 may include private servers 195 that are physically maintained by clients 165 or owners of clients 165. Private clouds 175 may be connected to the servers 195 over a private network 170. Hybrid clouds 175 may include both the private and public networks 170A, 170B and servers 195.

The cloud 175 may include back end platforms, e.g., servers 195, storage, server farms or data centers. For example, the cloud 175 can include or correspond to a server 195 or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, California). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Appliance Architecture

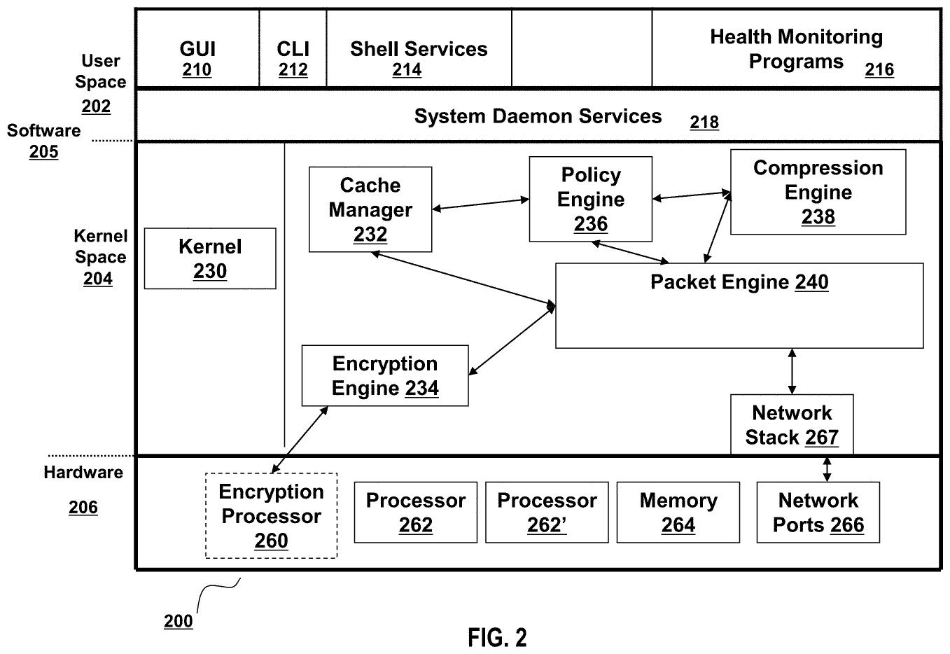

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 205 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of application 104. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reducing the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine if a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, FL. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

Additional details of the implementation and operation of appliance 200 may be as described in U.S. Pat. No. 9,538,345, issued Jan. 3, 2017 to Citrix Systems, Inc. of Fort Lauderdale, FL, the teachings of which are hereby incorporated herein by reference.

### C. Systems and Methods for Updating a Secure Sockets Layer (SSL) Certificate

The present disclosure is directed towards systems and methods for updating a SSL certificate for accessing one or more application services (e.g., microservices, cloud-based services, remote-hosted services, SaaS). For instance, the systems and methods described herein can provide a novel approach for efficiently monitoring and updating SSL certificates via one or more computing device(s) and/or client device(s) though one or more service(s) (e.g., Kestrel service, Open Web Interface for .NET (OWIN) service). A SSL certificate can be used for securing communications over a computer network. When a client device attempts to establish a SSL connection with a server, a server issues/provides an SSL certificate through a service to the client device. The service may be a worker service. The service may listen to any certificate request via a service bus queue for instance. The service may process the certificate request by calling a certificate authority to generate a SSL certificate in some scenarios, based on the certificate request in a message. In some embodiments, the service may monitor or check for an expiration of the SSL certificate. The service may renew the SSL certificate before or after expiration. The service may send a notification for generation of the SSL certificate to a service fabric cluster (e.g., to an Azure service fabric cluster with Azure key vault extension) after processing the certificate request.

In some embodiments, the systems and methods for updating a SSL certificate can be used in other services. For example, the systems and methods may be used in internet information services (IIS) hosted services on a virtual machine scale set. In certain embodiments, a virtual machine extension can be installed on scale set nodes to monitor SSL certificate(s) in a vault. When a vault adds/generates/updates/renews a SSL certificate, a service may download and install the latest SSL certificate from the vault. The service may install the SSL certificate into all corresponding cluster nodes. The service may store the SSL certificate in a certificate store and/or a cache of each of the corresponding cluster nodes. Since the SSL certificate can be stored in the cache, to provide fast and easy access to the SSL certificate in each of the corresponding cluster nodes. The present disclosure may provide an efficient or improved way to deploy/update/access one or more SSL certificate(s).

In view of the above discussion regarding installing, generating, updating, and/or identifying a SSL certificate, the present solution may be beneficial, as further explained in the following passages.

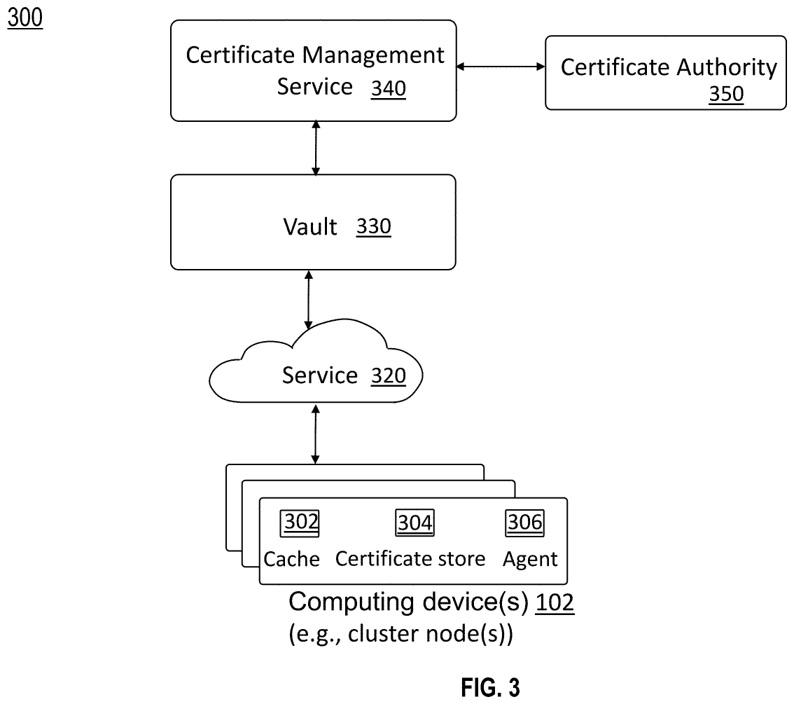

Referring to FIG. 3, depicted is a block diagram of one example embodiment of a system 300 for updating a SSL certificate. The system 300 may include one or more computing devices 102 (sometimes referred to as cluster node(s) 102), one or more services 320, a vault 330, a certificate management service 340, a certificate authority 350, and/or other components. In some embodiments, the computing device(s) 102 can comprise/be service fabric cluster node(s) and/or virtual machine scale set(s). The virtual machine scale set(s) may comprise group(s) of virtual machines having the same configuration (e.g., CPU, memory, and/or hard disk) managed by an orchestration service (e.g., Azure service fabric). When there is a load increase/decrease on the service then the orchestration service can (e.g., automatically) add/remove a virtual machine of the same configuration VM into the virtual machine scale set or fabric cluster.

Each of the above-mentioned elements or entities is implemented in hardware, or a combination of hardware and software, in one or more embodiments. Each component of the system 300 may be implemented using hardware or a combination of hardware or software detailed above in connection with FIG. 1C. For instance, each of these elements or entities can include any application, program, library, script, task, service, process or any type and form of executable instructions executing on hardware of a client device 102, a server 106 and/or a network device 200 in connection with FIGS. 1B-1C, for instance. The hardware includes circuitry such as one or more processors in one or more embodiments.

The computing device(s) 102 may have access to a cloud-based platform (e.g., servers) to access various resources. For example, the cloud-based platform may host virtual/remote/cloud-based applications (apps) and/or other services (e.g., Kestrel services, OWIN services, or microservices) that support or serve the computing device(s) 102. The computing device(s) 102 may execute, operate or otherwise provide an application, which can be any type and/or form of software, program, or executable instructions such as any type and/or form of web browser, web-based client, client-server application, a thin-client computing client, an ActiveX control, or a Java applet, or any other type and/or form of executable instructions capable of executing on the computing device (s) 102. In some embodiments, the computing device(s) can execute an application on behalf of a user or another computing device. In some embodiments, the computing device(s) can execute a virtual machine, which may provide an execution session within which applications execute on behalf of a user or another computing device. In certain embodiments, the execution session can be a hosted desktop session. The computing device(s) can include one or more cluster nodes, endpoint nodes, mobile devices, tablets, laptops, computers, and/or other client machines. The computing device(s) may execute one or more terminal services sessions. The computing device 102 may include a cache 302, an agent 304, and/or a certificate store 306. A user using the computing device, or an application executing on the computing device, may request access to an application service, and may request an SSL certificate to secure a communication channel/connection/session with the application service.

In some embodiments, the computing device(s) 102 may include a cache 302. The cache 302 can store and/or provide data (e.g., one or more SSL certificates, selected as having furthest expiration dates). Once the data is stored in the cache, the cached copy of the data can be efficiently accessed from the cache, rather than refetching the data from its source or recomputing the data. The cache may reduce an access time for a SSL certificates. The cache may comprise any type and form of storage element of the computing device(s), such as a portion of a random access memory.

In some embodiments, the computing device(s) 102 may include a certificate store 304. The certificate store 304 can store and/or provide data (e.g., SSL certificates) obtained/retrieved from a vault 330 (e.g., key vault) for instance. Once one or more new/updated SSL certificates are found/detected in the vault, the one or more new/updated SSL certificates may be obtained and installed in the certificate store (e.g., a cluster node certificate store, locally established/provided at a cluster node).

In some embodiments, the computing device(s) 102 may include an agent 306. The agent 306 (e.g., an Azure key vault extension, or an agent of a Kestrel or OWIN service) may retrieve/load/store one or more SSL certificate(s) to the cache 302 from the certificate store 306 in response to a request to access an application service/resource. In some implementations, the agent may be part of the service 320 (e.g. an agent of the service) and/or installed on the one or more computing devices by the service 320 (e.g., for local execution on a computing device). The service may perform (e.g., via the agent) any operation that is described herein as performed by the agent. After the agent stores one or more SSL certificate(s) in the cache and/or certificate store, the agent (or service) may monitor for a corresponding new/updated SSL certificate(s) in the vault (e.g., Azure key vault), e.g., periodically or when triggered by defined events. In some embodiments, the agent may detect one or more SSL certificate being added/updated in the vault. The agent (or service) may retrieve/load/store/install the corresponding one or more SSL certificate in the certificate store (e.g., Azure service fabric cluster node certificate store). In certain embodiments, the agent (or service) may retrieve/load the corresponding one or more SSL certificate(s) according to a schedule, e.g. periodically according to a configured time period (e.g., of a one-hour cycle). In some embodiments, the agent (or service) may search/request for or identify one or more SSL certificate(s) by a common name (e.g., domain name system (DNS) name, domain name, server name, host name, or a name with a wildcard component). In some implementations or systems, the cache and the certificate store may operate like a single device or distributed cache, and may collectively be referred as a cache or other store or storage device local to one or more computing devices.

In some embodiments, the system 300 may include a certificate authority 350. The certificate authority 350 (CA) may issue/provide/generate a valid SSL certificate. The certificate authority may be an entity that is trusted (e.g., to provide valid SSL certificates). In some implementations, a trusted SSL certificate may be difficult to deploy and configure. For some client device(s), the cost of obtaining a trusted SSL certificate may thus be prohibitive. A SSL certificate may include information such as a domain name, a company name, and an address of an organization that owns an associated server (e.g., providing the application service/resource).

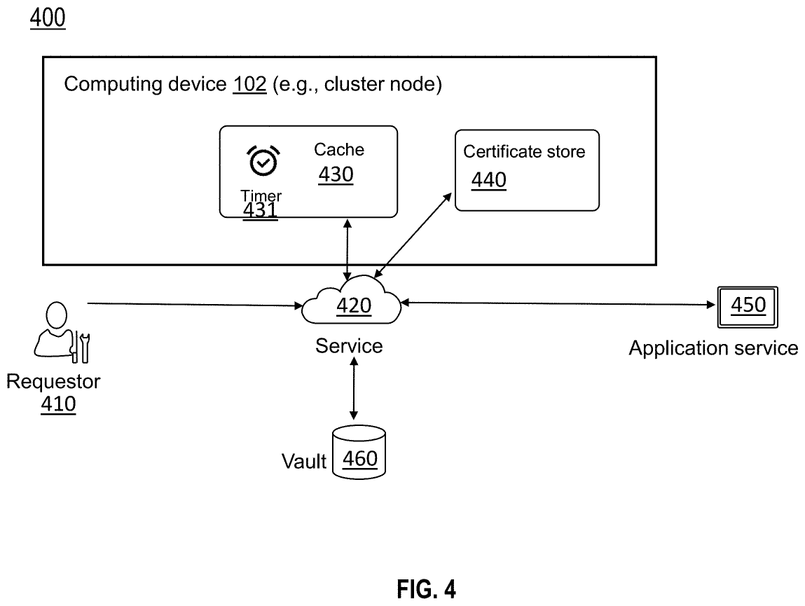

The system 300 may include one or more services 320 (e.g., Kestrel service, Open Web Interface for .NET (OWIN) service, for example in an Azure service fabric) for sending, identifying, determining, processing, providing, updating, and/or storing a SSL certificate. The services 320 may be located/hosted/executed at any one or more of a number of nodes (e.g., servers). The services may support or be accessed by one or more computing device(s). When a request to access a microservice is received for the very first time, the (local) cache and/or the certificate store may not include a SSL certificate to facilitate the request. Responsive to the absence/unavailability of a SSL certificate locally, a service 320 may send a request to the vault (e.g., Azure key vault/store) to identify and/or obtain one or more SSL certificates. The service may identify one or more SSL certificates by a common name (e.g., domain name system (DNS) name, domain name, server name, host name, or a name with a wildcard component) in respond to a request (e.g., microservice call, Kestrel callback event, or client request) to access an application service (e.g., microservice). The service may identify (or select) a first SSL certificate with a furthest expiration date among the one or more SSL certificates (sharing the common name). The service may store the first SSL certificate in the cache. In some embodiments, the service may store the first SSL certificate in each of a plurality of caches. The first SSL certificate may be used to secure a connection to access the application service. In some embodiments, the service may determine whether the first SSL certificate is available in the cache in response to a request to access the application service, which shall be discussed further detail in FIG. 4. In certain embodiments, the service may provide the first SSL certificate for use to secure a connection to access the application service.

In some embodiments, the system 300 may include a certificate management service 340. The certificate management service 340 may provide a SSL certificate inquiry service, to access/request SSL certificates from the certificate authority 350 (CA). The certificate management service 340 may convey SSL certificates and/or related communications between the vault 330 and the certificate authority 350. For example, when a request to access a microservice is received for the first time, a worker service/process in/of the certificate management service may request for the generation/provision of a SSL certificate by calling an application programming interface of the certificate authority 350. The certificate management service may store the SSL certificate generated/provided by the CA in the vault (e.g., Azure key vault/certificate store). In some implementations, the certificate management service (e.g., worker service) may publish a notification for generation of the SSL certificate, to a service fabric cluster (e.g., to an Azure service fabric cluster with Azure key vault extension). The notification may, in some implementations, trigger the service to access the vault for the generated SSL certificate, and/or to store the generated SSL certificate in a local certificate store and/or a local cache. The certificate management service may assign the service fabric cluster (e.g., Azure key vault extension with manage system identify (MSI)) with permission for accessing the vault (e.g., Azure key vault). The certificate management service may deploy/distribute/provide the SSL certificate to the service fabric cluster (e.g., Azure service fabric cluster with Azure key vault extension) via the vault.

In some embodiments, the system 300 may include a vault 330. The vault may be any type or form of storage device that holds/stores/maintains SSL certificates, keys and/or other files for deployment/distribution to various locations/parts of a network, such as to a number of computing devices. The vault 330 (e.g., Azure key vault extension) may communicate with a certificate authority 350 (e.g., via the certificate management service 3400 in order to monitor for and load/obtain SSL certificates available via the certificate management service, for holding in the vault. The vault may store a plurality of SSL certificates provided by the certificate management service from the CA.

Referring now to FIG. 4, depicted are block diagrams of example embodiments of a system 400 for updating a SSL certificate. In FIG. 4, the system 400 may include a requestor 410, a service 420, a computing device 102, an application service 450, and/or a vault 460.

In certain embodiments, the system 400 may include an application service 450. The application service may provide access to an application service/resource via a secure network connection. In some embodiments, the application service may perform interior Hold exchange, load balancing, application performance monitoring, application acceleration, autoscaling, micro-segmentation, service proxy, service discovery, and/or SSL VPN session establishment and/or management.

In certain embodiments, the system 400 may include a requestor 410. The requestor 410 may send a request to access an application service 450, and a service 420 may receive/detect/intercept the request. The service 420 may (e.g., in response to the request) determine whether a SSL certificate is available in a cache 430. If the service determines that the SSL certificate is available in the cache, the service may provide the SSL certificate for use to secure a connection to access the application service 450. In some embodiments, if the service determines that the SSL certificate is unavailable/absent/expired in the cache, the service may send another request to the vault 460 to identify another SSL certificate (e.g., to transfer to the certificate store 440). The service may identify another SSL certificate with a furthest expiration date, from one or more SSL certificates that share a common name (e.g., domain name system (DNS) name, domain name, server name, host name, or a name with a wildcard component). The certificate store and/or cache may store one or more of a plurality of SSL certificates identified from a vault 460 by the common name. In some embodiments, all or some of the latest SSL certificates in a vault may be selected and may be stored into the certificate store 440 and/or cache in each cluster node. In some embodiments, the vault 460 may be located on a cloud (e.g., on one or more servers).

In some embodiments, the service 420 can determine, in response to the request, whether a SSL certificate is available in a cache 430. A SSL certificate may be used for securing (e.g., encrypting) communications transmitted over a network. In certain embodiments, the service can part of a service fabric (e.g., in Citrix's or other cloud platform). In some embodiments, the service (e.g., OWIN service) may load a SSL certificate from the vault into the certificate store. The SSL certificate may be selected from the vault, as having the furthest expiration date among one or more SSL certificates with the same common name in the vault. In some embodiments, the service (e.g., Kestrel service) may be invoked for every client request (e.g., to access an application service/resource and/or to access/use an SSL certificate). Once the service (and/or an agent) detects/identifies a SSL certificate having the furthest expiration date among one or more SSL certificates, the service may provide the SSL certificate to the cache to reduce access overhead, and to improve performance of accessing microservices for instance. The service may configure a time interval (e.g., one hour or other value) for each SSL certificate, to specify a time duration/window during which the SSL certificate is valid, and/or a time at which the SSL certificate is to expire (e.g., becomes invalid). In certain embodiments, after the configured time interval expires/ends/elapses (or the configured time occurs), the service may try to load a new/replacement SSL certificate from the certificate store to the cache.

The cache 430 may include a timer 431 that may operate/run according to the time interval or the configured time, to maintain validity of the SSL certificate during the time interval or up to the configured time. Each SSL certificate may include or be associated with a corresponding timer 431. The service may initiate the corresponding timer for each SSL certificate. After the time interval ends/expires, the SSL certificate may become unavailable in the cache 430 (e.g., is purged or removed from the cache, or marked as invalid in the cache). In some embodiments, the time interval or configured (expiration) time of a cached SSL certificate can be set to be of the same order of granularity as a time interval of a timer for packet processing, such as at every hour, second or millisecond (or other value). In some embodiments, the cache may hold/keep the expired SSL certificate for a certain time after expiration. In certain embodiments, the cache may delete or clean/flush out the expired SSL certificate immediately after expiration.

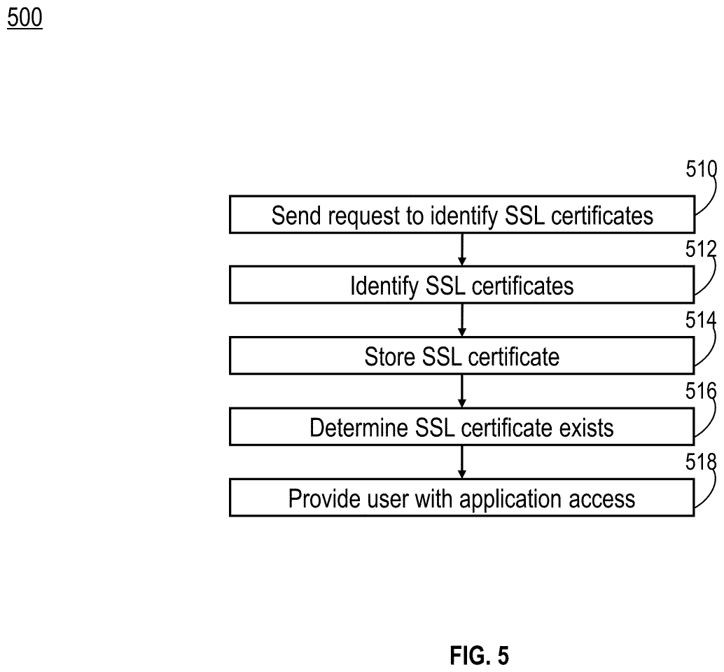

Referring to FIG. 5, depicted is a flow diagram 500 of one embodiment of a method for updating a SSL certificate. The functionalities of the method may be implemented using, or performed by, any one or more of the components detailed herein in connection with FIGS. 1-4. In brief overview, a computing device 102 may send a request to identify SSL certificates (510). The computing device 102 may identify SSL certificates by a common name (512). The computing device 102 may store a SSL certificate with a furthest expiration date among the identified SSL certificates, in a cache (514). The computing device 102 may determine if a SSL certificate exists in the cache (516). The computing device 102 may provide a user with access to an application service/resource (518).

In some embodiments, a requestor (e.g., a user, an application, or a service/microservice) may initiate/trigger or send a request to access an application service (e.g., another service/miroservice). The server may detect/receive/intercept the request. The service may (e.g., in response to the request) determine whether an SSL certificate is available in a cache. If not, the service may proceed to operation 510 in response to the request (e.g., a request initiated for the very first time by the requester, in a session for instance).

Referring now to operation (510), and in some embodiments, a service 320 (e.g., a server and/or other devices) may send a request to a vault (e.g., Azure key vault/store in an Azure Service Fabric) to identify and/or obtain one or more secure sockets layer (SSL) certificates. For example, the request may comprise a query that includes/specifies a string or identifier for searching/selecting certain SSL certificates. The string or identifier may comprise a common name (e.g., associated with the requested application resource/service, and/or the requester). The one or more SSL certificates may be identifiable by the common name. The request may be a response to a new/first request from a requestor (e.g., in a new/first session of the requestor). In some embodiments, the request may be in response to a first request to access an application service. The first request may include an application programming interface (API) request, a microservice request, and/or a callback event. The common name can be a domain name system (DNS) name, a domain name, a server name, a host name, or a name with a wildcard component. The vault may provide/reply to the service, in response to the request/query, a message/information indicating one or more SSL certificates that match or correspond to the common name (or string or identifier). In some scenarios, no SSL certificate may be identified in response to the request/query. Such a scenario may trigger the generation/provision of a SSL certificate. In some embodiments, a certificate management service may (e.g., in response to the latter scenario) request for the generation/provision of a SSL certificate from a certificate authority (CA). For instance, the certificate management service may request the CA for a SSL certificate (e.g., sometimes referred to as a server/client/session certificate) to be configured/generated for accessing the requested application service/resource (e.g., a SSL certificate having the common name). The certificate management service may store the SSL certificate(s) generated/provided by the CA in/to the vault for (e.g., future) fetching by the service.

Referring now to operation (512), and in some embodiments, the service 320 (and/or agent) may identify one or more SSL certificates that share a common name in the vault in response to the request from the requestor. The service may identify a SSL certificate with a furthest expiration date among the one or more SSL certificates. The service may identify/select a SSL certificate that can stay valid (or last) for the longest period of time (e.g., so as to maximize/lengthen the amount of time before the service may be triggered to get a replacement/updated SSL certificate due to expiry of the present SSL certificate). In some embodiments, the service may specify/identify the SSL certificate (with the furthest expiration date) to the vault, to download/retrieve/access the SSL certificate from the vault, to load into a certificate store (and/or a cache). For example, the service may store the SSL certificate to a certificate store for one or more computing devices, and an agent of the service may (e.g., automatically) obtain the SSL certificate from the certificate store, and may store the SSL certificate to a cache (e.g., of a computing device). In some embodiments, the service may directly obtain and store the SSL certificate from the vault to the cache.

In some embodiments, the service 320 may store/install the SSL certificate having a furthest expiration date from the vault in a certificate store (e.g., Azure service fabric cluster node certificate store). The certificate store may store/keep/hold/maintain a plurality of SSL certificates that share a common name from the vault, and may store one or more other SSL certificates not sharing the common name. The certificate store can be located in a cloud storage, or at a central location/device accessible by the service/agent and/or by a plurality of computing devices. In some embodiments, the service may download and install a SSL certificate in the certificate store, when the vault adds/receives/updates/renews the SSL certificate.

Referring now to operation (514), and in some embodiments, the service 320 may store the SSL certificate in a cache. The service 320 (e.g., via one or more agents of the service) may store the SSL certificate in each of a plurality of caches of a plurality of cluster nodes. The SSL certificate can be used to secure/encrypt a connection/session/channel to access or communicate with the application service. The service may store the SSL certificate in the certificate store and/or the cache of each of the corresponding cluster nodes. The cached SSL certificate may reduce access overhead by being readily available for fast retrieval from the cache (as compared to the vault or certificate store), which can reduce latency/delays in loading/accessing the SSL certificate one or more times for accessing microservices for instance.

In some embodiments, the service 320 may initiate/set a timer for the SSL certificate in the cache. The timer may be configured to track (or to run/execute/count over) a time interval to maintain validity of the SSL certificate during the time interval. After the time interval ends/expires, the SSL certificate may expire, and can become unavailable in the cache. In some embodiments, after the time interval ends/expires, the service may access the certificate store, and/or send a request to the vault, to identify one or more SSL certificates (e.g., operation 510) and can repeat operations 512 and 514.

Referring now to operation (516), and in some embodiments, the service 320 may determine whether the SSL certificate is available in the cache, in response to a second request to access the application service or another application service. The second request may occur at a time that is different from the time of the aforementioned/prior request to access the application service. If the service determines that the SSL certificate is available and valid in the cache, the service may proceed to operation 518 (e.g., to provide secure access to the application service). In certain embodiments, if the service determines that the SSL certificate is unavailable/absent/expired in the cache, the service may check the certificate store and/or the vault (e.g., send another request to the vault) to identify and/or obtain another SSL certificate (e.g., operation 510). The latter operation/process is sometimes referred to as updating the (expired) SSL certificate, or acquiring an updated (or replacement/new) SSL certificate.

Referring now to operation (518), and in some embodiments, the service 320 may provide the SSL certificate, which is available in the cache, for use (e.g., /by the requester, from a computing device or cluster node machine for instance) to secure the connection/session/channel to access the application service or to secure a connection/session/channel to the another application service. The service may send/transmit the SSL certificate to the requestor, or may grant the requestor with access to the SSL certificate (e.g. in the cache). In some embodiments, the requestor may use the SSL certificate, or information of the SSL certificate, to encrypt/secure packets/frames/traffic/communications to/from/of the application service. The requestor may use the SSL certificate, or information of the SSL certificate to establish a SSL/secure connection/session/channel between the requester (e.g., computing device or cluster node machine) and a server/appliance providing the application service. The application service may include/be one or more microservices, cloud-based services, remote-hosted services, SaaS, interior Hold exchange, etc. The application service may include a service for performing any type or form of service/operation, such as load balancing, information retrieval, data processing, transaction processing, application performance monitoring, application acceleration, autoscaling, micro-segmentation, service proxy, service discovery, and/or SSL VPN session establishment and/or management, for instance.

In some embodiments, the service 320 may (periodically, or be triggered by certain events/conditions to) monitor/check and/or request for one or more SSL certificate(s) in the vault that shares the same common name as the SSL certificate (e.g., in the cache/certificate store). For instance, upon expiry of an existing SSL certificate in the cache, in response to an absence of a valid SSL certificate in the cache, and/or in response to a request to access an application service, the service may check for the availability of a new/replacement/updated SSL certificate. If the service finds/detects/identifies a new/updated SSL certificate in the vault, corresponding to the SSL certificate in the cache or certificate store, the service may download/retrieve and install the SSL certificate from the vault into the certificate store/cache. The new/updated SSL certificate may have the furthest expiration date among the plurality of SSL certificate (sharing the common name) in the vault. In some scenarios, the new/updated SSL certificate may be the only available one in the SSL certificate that is associated with the desired common name. In some embodiments, if the only available SSL certificate in the vault has an expiration date that is within a certain threshold (e.g., the SSL certificate shall expire soon), the service and/or the vault may trigger/request the certificate management service to obtain/request one or more SSL certificates (e.g., that has longer expiration date(s)) from the CA.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

We claim:

1. A method comprising:
sending, by a service executable on at least one server, a request to a vault to identify one or more secure sockets layer (SSL) certificates identifiable by a common name, in response to a first request to access an application service;
identifying, by the service, a first SSL certificate having a furthest expiration date among the one or more SSL certificates; and
storing, by the service, the first SSL certificate in a cache, the first SSL to be used to secure a connection to access the application service.

2. The method of claim 1, comprising:
determining, by the service, whether the first SSL certificate is available in the cache, in response to a second request to access the application service or another application service.

3. The method of claim 2, comprising:
determining, by the service, that the first SSL certificate is available in the cache; and
providing, by the service, the first SSL certificate for use to secure the connection to access the application service or a connection to the another application service.

4. The method of claim 2, comprising:
determining, by the service, that the first SSL certificate is unavailable in the cache; and
sending, by the service, another request to the vault to identify another one or more SSL certificates identifiable by the common name.

5. The method of claim 4, comprising:
identifying, by the service, a second SSL certificate having a furthest expiration date among the another one or more SSL certificates; and
storing, by the service, the second SSL certificate in the cache, the second SSL to be used to secure the connection to access the application service or the connection to access the another application service.

6. The method of claim 5, comprising:
providing, by the service, the second SSL certificate to secure the connection to access the application service or the connection to access the another application service.

7. The method of claim 1, wherein the common name comprises a domain name system (DNS) name or a domain name.

8. The method of claim 1, comprising:
initiating, by the service, a timer for the first SSL certificate in the cache, wherein upon expiration of the timer, the first SSL certificate becomes unavailable in the cache.

9. The method of claim 1, wherein the first request includes at least one of: an application programming interface (API) request, a microservice request, or a callback event.

10. The method of claim 1, comprising:
storing, by the service, the first SSL certificate in each of a plurality of caches.

11. At least one server comprising:
at least one processor configured to execute a service to:
send, via a transmitter, a request to a vault to identify one or more secure sockets layer (SSL) certificates identifiable by a common name, in response to a first request to access an application service;
identify a first SSL certificate having a furthest expiration date among the one or more SSL certificates; and
store the first SSL certificate in a cache, the first SSL to be used to secure a connection to access the application service.

12. The at least one server of claim 11, wherein the at least one processor is configured to execute the service to determine whether the first SSL certificate is available in the cache, in response to a second request to access the application service or another application service.

13. The at least one server of claim 12, wherein the at least one processor is configured to execute the service to:
determine that the first SSL certificate is available in the cache; and
provide the first SSL certificate for use to secure the connection to access the application service or a connection to the another application service.

14. The at least one server of claim 12, wherein the at least one processor is configured to execute the service to:
determine that the first SSL certificate is unavailable in the cache; and
send another request to the vault to identify another one or more SSL certificates identifiable by the common name.

15. The at least one server of claim 14, wherein the at least one processor is configured to execute the service to:
identify a second SSL certificate having a furthest expiration date among the another one or more SSL certificates; and
store the second SSL certificate in the cache, the second SSL to be used to secure the connection to access the application service or the connection to access the another application service.

16. The at least one server of claim 15, wherein the at least one processor is configured to execute the service to provide the second SSL certificate to secure the connection to access the application service or the connection to access the another application service.

17. The at least one server of claim 11, wherein the common name comprises a domain name system (DNS) name or a domain name.

18. The at least one server of claim 11, wherein the at least one processor is configured to execute the service to initiate a timer for the first SSL certificate in the cache, wherein upon expiration of the timer, the first SSL certificate becomes unavailable in the cache.

19. The at least one server of claim 11, wherein the at least one processor is configured to execute the service to store the first SSL certificate in each of a plurality of caches.

20. A non-transitory computer-readable medium storing instructions that, when executed by at least one processor of a service, cause the at least one processor to:
send, via a transmitter, a request to a vault to identify one or more secure sockets layer (SSL) certificates identifiable by a common name, in response to a first request to access an application service;
identify a first SSL certificate having a furthest expiration date among the one or more SSL certificates; and
store the first SSL certificate in a cache, the first SSL to be used to secure a connection to access the application service.
